(19) United States
(12) Patent Application Publication
(10) Pub. No.: US 2021/0378278 A1
(43) Pub. Date: Dec. 9, 2021

(54) NON-AGGLOMERATED COMPOSITION OF COLLAGEN HYDROLYSATE AND AMORPHOUS GELATIN

(71) Applicant: Tessenderlo Group NV, BRUSSELS (BE)

(72) Inventor: Yingying WU, Ertvelde (BE)

(21) Appl. No.: 17/431,741

(22) PCT Filed: Feb. 18, 2020
(86) PCT No.: PCT/EP2020/054253

§ 371 Date: Aug. 18, 2021

(30) Foreign Application Priority Data
Feb. 18, 2019 (EP) 19157849.1

(51) Int. Cl. A23L 29/281

(52) U.S. Cl. CPC A23L 29/284; A23V 2002/00

(57) ABSTRACT

The present invention relates to a composition comprising collagen hydrolysate and amorphous gelatin, said composition being non-agglomerated. The invention is particularly useful in the production of various food products, more particularly healthy food products in need of texture. Also the invention is useful in the production of pet food, cosmetic or pharmaceutical products.

### TECHNICAL FIELD

The present invention relates to a composition comprising collagen hydrolysate and amorphous gelatin, said composition being non-agglomerated.

The invention is particularly useful in the production of various food products, more particularly healthy food products in need of texture. The invention is also useful in the production of pet food products, cosmetic products or pharmaceutical products to provide texture.

### BACKGROUND

Nowadays consumers are increasingly looking for healthy foods. In particular the beneficial effects of collagen hydrolysate on health have been recognized and the demand for convenience foods comprising collagen hydrolysate is ever growing. At the same time, consumers want to enjoy their food and one property that is gaining importance is texture. However, collagen hydrolysate being a soluble protein, it is not an ingredient that is capable of providing texture to food products. Collagen hydrolysate is the product of the hydrolysis of gelatin to an extent that it is no longer capable of gelling contrary to gelatin which has at least some gelling ability. This property of collagen hydrolysate limits its use in these applications where texture plays an important role. Depending on the specific type of application, texture is important for maintaining the shape of the product, for maintaining the stability of the product such that it remains appealing to the customer, for providing a certain hardness to the product, for providing desired organoleptic properties and mouth feel to the product and the like. Texture has thus a different meaning depending on the type of application; texture can be softness, airiness, gooeyness, smoothness, hardness and the like.

Existing solutions to provide a high dosage of collagen hydrolysate comprise dissolving collagen hydrolysate into liquid products such as juices, milk, coffee and so on. There is no provision of texture, which limits the use of collagen hydrolysate. Typically texture is provided by using formulations of food texturizing ingredients specifically designed for each type of application and texture need. For example, ingredients such as instant starches can be used, which are not always desired as they introduce carbohydrates, especially in formulations for specific health conditions or diets. Further, some ingredients require specific process steps in the preparation of the food application, such as heating for example. This can be disadvantageous for micronutrients such as vitamins for example.

There is thus a need for a single solution to provide protein enhanced applications, at the same time allowing to obtain in an easy way, various textures in various food applications, without the need to use or develop extensive formulations with several food texturizing ingredient. The present invention provides for such a solution.

### SUMMARY OF THE INVENTION

The present invention relates in a first aspect to a composition comprising:
a. From 45 to 90 wt % collagen hydrolysate on dry basis of the composition (wt % db) and
b. From 10 to 55 wt % db of amorphous gelatin
Characterized in that the composition is non-agglomerated.

The present invention relates in a further aspect to a process for making the composition of the present invention comprising blending from 45 to 90 wt % of collagen hydrolysate and from 10 to 55 wt % of amorphous gelatin.

In still a further aspect, the present invention relates to a food product, pet food product, cosmetic product or pharmaceutical product comprising the composition of the present invention and further food ingredients, pet food ingredients, cosmetic ingredients or pharmaceutical ingredients.

In still a further aspect, the present invention relates to the use of the composition of the first aspect of the present invention to provide various textures to food products.

### DETAILED DESCRIPTION The present invention relates in a first aspect to a composition comprising:

a. From 45 to 90 wt % db of collagen hydrolysate and
b. From 10 to 55 wt % db of amorphous gelatin,
Characterized in that the composition is non-agglomerated.

Preferably the gelatin composition of the present invention comprises from 50 to 90 wt %, more preferably from 55 to 85 wt % db, even more preferably from 60 to 80% db, yet even more preferably from 60 to 75 wt % db, yet even more preferably from 60 to 70 wt % db, yet even more preferably from 60 to 65 wt % db of collagen hydrolysate.

Preferably further, the gelatin composition of the present invention comprises from 15 to 50 wt % db, more preferably from 20 to 45 wt % db, even more preferably from 25 to 40 wt %, even more preferably from 30 to 40 wt %, yet even more preferably from 35 to 40 wt % of amorphous gelatin.

In the context of the present invention, amorphous gelatin means a gelatin that has an amorphous proportion of 95% or more, preferably of 98% or more, preferably of 99% or more. Amorphous gelatin is also referred to as cold soluble gelatin or instant gelatin and is, compared to standard (crystalline) gelatins, able to be dissolved in cold water, such as water at room temperature. Amorphous gelatin may be produced for example by drum drying.

Collagen is the main component of connective tissues in animals and humans. Collagen consists of chains of amino acids wound together to form triple-helices which in turn form elongated fibrils. It is mostly found in fibrous tissues such as tendons, ligaments and skin. It is also found in bones, teeth, corneas, cartilage, intervertebral discs and blood vessels. Collagen for industrial processing is mostly derived from animal skin and/or bones. Collagen may be processed to produce gelatin, which is obtained by irreversible, partial hydrolysis of collagen. According to the Food Chemical Codex, gelatin is defined as the product obtained from the acid, alkaline, or enzymatic hydrolysis of collagen, the main protein component of the skin, bones, and connective tissue of animals, including fish and poultry. Gelatin is typically characterized by a gel strength (gelatin has the ability to form gels of various strengths, depending on the gelatin properties) and in warm solution by a certain viscosity. This gelatin can be further hydrolyzed to shorter protein chains to produce collagen hydrolysate, losing its ability to form a gel and becoming even soluble in water at ambient temperatures. Hydrolysis can be done by an enzymatic treatment for example.

Collagen hydrolysate for the purpose of the present invention preferably has an average molecular weight distribution of 300 to 15000 Da, preferably from 500 to 10000 Da, preferably from 600 to 10000 Da, preferably from 700 to 10000 Da, preferably from 800 to 10000 Da, preferably from 900 to 10000 Da, preferably from 1000 to 10000 Da, preferably from 1500 to 10000 Da, preferably from 1700 to 9000 Da, preferably from 2000 to 7000 Da, preferably of from 2000 to 5000 Da, more preferably of from 2500 to 4500 Da, even more preferably of from 2700 to 4000 Da, yet even more preferably of from 2800 to 3800 Da (average molecular weight (Mw) measured by gel permeation chromatography (Size exclusion chromatography using linear polymers such as polystyrene sulfonates or collagen chain fragments of different molecular weights as calibration vehicles). As mentioned above, collagen hydrolysate, contrary to gelatin, does not have the ability to form gels.

As mentioned above, the composition of the present invention is non-agglomerated, i.e. it is substantially non-agglomerated, i.e. at least 80 wt %, more preferably at least 85 wt %, more preferably at least 90 wt %, even more preferably at least 95 wt %, yet even more preferably at least 99 wt %, most preferably 100 wt % is non-agglomerated. This means that the composition, i.e. the mixture of collagen hydrolysate and gelatin as defined herein, is not processed in a specific way (e.g. agglomeration, granulation, compaction and the like) to produce bigger particles. It may however be that the separate ingredients are provided in an agglomerated form. Thus, the collagen hydrolysate may be in agglomerated form, meaning that it has been agglomerated before being mixed with the amorphous gelatin to produce the composition of the present invention. Also further, the amorphous gelatin may be in an agglomerated form.

The protein hydrolysate can be in powder form, non-agglomerated. The protein hydrolysate is then further characterized in that it has a d50 of from 65 to below 100 μm, preferably from 70 to 90 μm. Or, the protein hydrolysate can be in agglomerated form. The protein hydrolysate is then further characterized in that it has a d50 particle size of from 100 to 1000 μm, preferably from 110 to 800 μm, more preferably from 120 to 600 μm, even more preferably from 130 to 500 μm, yet even more preferably from 140 to 400 μm, yet even more preferably from 150 to 300 μm, yet even more preferably from 160 to 250 μm, yet even more preferably from 170 to 250 μm, most preferably from 170 to 200 μm. In the present description d50 means the particle size where 50% of the volume fraction of the particles is larger than the indicated d50 value, and 50% is smaller than the d50 indicated value.

It is measured on dry product by laser diffraction on a Beckman Coulter particle size analyzer using standard software.

The gelatin can have a d50 of from 65 to below 100 μm, preferably from 70 to 90 μm. Or the gelatin can be in agglomerated form, it is then further characterized in that it has a d50 particle size of from 100 to 1000 μm, preferably from 110 to 800 μm, more preferably from 120 to 600 μm, even more preferably from 130 to 500 μm, yet even more preferably from 140 to 400 μm, yet even more preferably from 150 to 300 μm, yet even more preferably from 160 to 250 μm, yet even more preferably from 170 to 250 μm, most preferably from 170 to 200 μm.

Similarly, the composition of the present invention can have a d50 of from 65 to below 100 μm, preferably from 70 to 90 μm. Or the composition of the present invention can be characterized in that it has a d50 particle size of from 100 to 1000 pm, preferably from 110 to 800 μm, more preferably from 120 to 600 μm, even more preferably from 130 to 500 μm, yet even more preferably from 140 to 400 μm, yet even more preferably from 150 to 300 μm, yet even more preferably from 160 to 250 μm, yet even more preferably from 170 to 250 μm, most preferably from 170 to 200 μm.

Preferably, the gelatin is characterized by a bulk density or bulk weight of from 200 up to 650 g/l, more preferably from 200 up to 640 g/l, more preferably from 200 to up to 620 g/l, more preferably from 220 to 600 g/l, even more preferably from 250 to 550 g/l, yet even more preferably from 300 to 500 g/l, yet even more preferably from 350 to 450 g/l.

Further, the composition of the present invention preferably has a moisture content of 2 to 8 wt %, preferably from 3 to 6 wt %, more preferably from 4 to 5 wt %.

The present invention further relates to a process to produce a non-agglomerated gelatin composition comprising blending from 45 to 90 wt % of collagen hydrolysate and from 10 to 55 wt % of amorphous gelatin.

The present invention further relates to a composition comprising collagen hydrolysate and amorphous gelatin obtainable by the process of the present invention.

The present invention further relates to a food product comprising the gelatin composition of the present invention and further food ingredients. The gelatin composition of the present invention is advantageous for use in various food products by providing a high amount of collagen hydrolysate, which is known for its health benefits, while at the same time providing different texture possibilities. The present composition is further advantageous for its ease of use in various food applications, such as easy dissolution without the need of heating. This is among other things advantageous in that temperature sensitive ingredients and especially nutrients such as vitamins are preserved, which helps to maximize the nutritious content of foods and is beneficial for the consumer.

The food product may be smoothies, snacks, juices, jellies, spreads, beverages such as sport beverages, milk, vegetable milks, protein shakes, dairy desserts, ice creams, water ices, mousses, protein bars, cakes such as cheesecakes for example. Ingredient for the above mentioned food products are well-known by the skilled person and typically include fruits, vegetables, vitamins, flavour and so on. The possibilities of textures that can be obtained by using the composition of the present invention in the different applications are manifold: silkiness, smoothness, softness, gooeyness, lightness, airiness, hardness, chewiness, creaminess, thickness and so on. This allows to provide the healthy collagen hydrolysate in many different applications.

The food product may be prepared by adding the composition during the manufacturing process or alternatively by adding the individual ingredients of the composition of the present invention during the manufacturing process as they will still provide the desired texturizing effect. Preferably however, the food product is prepared by adding the collagen hydrolysate and amorphous gelatin as the composition of the present invention during the manufacturing process of the food product.

The present invention further relates to a pet food product comprising the gelatin composition of the present invention and further pet food ingredients. The pet food product may be dry pet food, wet pet food for example.

The present invention further relates to a pharmaceutical product comprising the gelatin composition of the present invention and further pharmaceutical ingredients. The pharmaceutical product may be a tablet, a syrup for example.

The present invention further relates to a cosmetic product comprising the gelatin composition of the present invention and further cosmetic ingredients. The cosmetic product may be a hand or foot cream, body milk, skin care product, eye care product, hair care product for example.

The present invention further relates to a process for preparing a food, a pet food product, a cosmetic or a pharmaceutical product, which process comprises using, preferably dissolving, the composition of the present invention, and which process comprises combining with further food, pet food, cosmetic or pharmaceutical ingredients respectively. Dissolving may be done in water or in any other liquid ingredient used in the preparation of the food or pet food product. Preferably dissolving is done using shear, more preferably high shear. Combining with further ingredients may be done by mixing, shaking, stirring, compacting, tabletting, molding and the like.

In a further aspect, the present invention relates to the use of the composition of the present invention to provide texture to food products, pet food products, cosmetic products or pharmaceutical products. Food products are for instance confectionary products, convenience products, dairy products, bakery products and the like.

Texture means hardness, softness, brittleness, gooeyness, stickiness, airiness and the like, depending on the specific food product, pet food product, cosmetic product or pharmaceutical product.

The present invention is illustrated by the non-limiting examples below.

### EXAMPLES

### Example 1: Apple Cinnamon Snack

Following ingredients are provided:
200 ml of apple juice at 20° C.
1 teaspoon of cinnamon powder
A pinch of sea salt
30 g of a blend of 50 wt %collagen hydrolysate (Solugel® from PB Leiner) and 50 wt % of amorphous gelatin (Cryogel ® from PB Leiner).

The apple juice, cinnamon and salt are poured into a bowl. The blend of collagen hydrolysate and amorphous gelatin is added slowly while stirring with a hand whisk until the mixture becomes thick and smooth. The mixture is then poured into silicone moulds of desired shape and put in the refrigerator for 30 minutes to allow the mixture to set.

1. A composition characterized in that it comprises
a. From 45 to 90 wt % db collagen hydrolysate and
b. From 10 to 55 wt % db of amorphous gelatin
Characterized in that the composition is non-agglomerated.

2. The composition according to claim 1 or 2, characterized in that it the amorphous gelatin has a bulk weight of from 200 to 650 g/l.

3. The composition according to any one of the previous claims, further characterized in that the collagen hydrolysate has a molecular weight distribution of from 300 to 15000 Da.

4. The composition according to any one of claims 1 to 3, further characterized in that it has d50 of from 65 to below 100 μm.

5. The composition according to any one of the previous claims, further characterized in that the collagen hydrolysate and/or the amorphous gelatin is in agglomerated form.

6. The composition according to claim 5, further characterized in that it has a d50 of from 100 to 1000 μm.

7. The composition according to any one of the previous claims characterized in that the collagen hydrolysate is derived from one or more of pork skin, beef hides, pork bones and beef bones.

8. The composition according to any one of the previous claims characterized in that the gelatin is derived from one or more of pork skin, beef hides, pork bones and beef bones.

9. A process to produce a non-agglomerated gelatin composition comprising blending from 45 to 90 wt % of collagen hydrolysate and from 10 to 55 wt % of amorphous gelatin.

10. A food product, pet food product, cosmetic product or pharmaceutical product comprising the composition of any one of claims 1 to 8 and further food, pet food, cosmetic or pharmaceutical ingredients.

11. The food product of claim 10 characterized in that it is a confectionary product, a convenience product, a dairy product or a bakery product.

12. The food product, pet food product, cosmetic product or pharmaceutical product of claim 11 characterized in that it comprises from 1 to 15 wt % of the composition of any one of claims 1 to 8.

13. A process for preparing a food product, a pet food product, cosmetic product or a pharmaceutical product, which process comprises using, preferably dissolving the composition of any one of claims 1 to 8, or obtainable by the process of claim 9 and which process comprises combining with further food ingredients, pet food ingredients, cosmetic ingredients or pharmaceutical ingredients.

14. Use of the composition of any one of claims 1 to 8, or obtainable by the process of claim 9, to provide texture to food products, such as confectionary products, convenience products, dairy products, bakery products and the like, to pet food products, to cosmetic products or to pharmaceutical products.

15. Use according to claim 14, wherein texture is hardness, softness, brittleness, gooeyness, stickiness, airiness and the like.
